(19) United States
(12) Patent Application Publication
(10) Pub. No.: US 2022/0086943 A1
(43) Pub. Date: Mar. 17, 2022

(54) METHOD FOR CONTROLLING A COMMUNICATION BETWEEN A VEHICLE AND A BACKEND DEVICE

(71) Applicant: Volkswagen Aktiengesellschaft, Wolfsburg (DE)

(72) Inventor: Frederik Bas, Vught (NL)

(21) Appl. No.: 17/469,459

(22) Filed: Sep. 8, 2021

(30) Foreign Application Priority Data
Sep. 11, 2020 (EP) 20195710.7

(51) Int. Cl. H04W 76/25; H04W 76/14; H04W 4/44

(52) U.S. Cl. CPC H04W 76/25; H04W 4/44; H04W 76/14

(57) ABSTRACT

Technologies and techniques for controlling a communication between a vehicle and at least one backend device in a vehicle-to-cloud-system. A connection is established between the vehicle and the at least one backend device with a keep-alive timer. A timer is set to be less than or equal to the keep-alive timer, and a message is sent, containing a payload from the vehicle to the at least one backend device, if no communication between the vehicle and the at least one backend device has occurred within the timer, in order to keep the connection open.

### CROSS REFERENCE TO RELATED APPLICATION

The present application claims priority to European Patent App. No. 20195710.7, to Frederik Bas, filed Sep. 11, 2020, the contents of which is incorporated by reference in its entirety herein.

### FIELD OF TECHNOLOGY

The present disclosure is related to technologies and techniques for controlling a communication between a vehicle and at least one backend device in a vehicle-to-cloud-system, especially from the vehicle side of the system, according to the independent method claim. Further, the present disclosure is related to an electronic control unit according to the independent device claim. Furthermore, the present disclosure is related to a vehicle comprising a corresponding electronic control unit according to the second independent device claim. Moreover, the present disclosure is related to a computer program product for a corresponding method according to the independent product claim.

### BACKGROUND

Vehicle communication systems using a publish-subscribe messaging protocol are basically known, for example from DE 10 2018 130 216 A1. By establishing a connection between a vehicle and a backend device, for example cloud server, the vehicle sends a connect message to the backend device with a defined keep alive timer. If the open connection is not used for a time set with the keep alive timer, the vehicle will generate a ping request message and expect to receive a ping response message from the backend device to keep the connection open. Ping messages have no useful content and cause non-useful traffic for the network.

### SUMMARY

Aspects of the present disclosure are to provide a method for controlling a communication between a vehicle and at least one backend device in a vehicle-to-cloud-system, especially from the vehicle side of the system, with improved connectivity. Aspects of the present disclosure also include providing a method for controlling a communication between a vehicle and at least one backend device in a vehicle-to-cloud-system, which enables to keep the connection between the vehicle and the backend device open in an easy, but useful way, preferably without non-useful traffic for the network. Also, aspects of the present disclosure are to provide a corresponding electronic control unit for the vehicle, a corresponding vehicle and a related computer program product for the inventive method.

In some examples, a method is disclosed for controlling a communication between a vehicle and at least one backend device in a vehicle-to-cloud-system, especially from the vehicle side of the system, with the features of the independent method claim. In some examples, an electronic control unit is disclosed with the features of the independent device claim. In some examples, a vehicle is disclosed comprising a corresponding electronic control unit with the features disclosed herein. Other aspects of the present disclosure include a corresponding vehicle-to-cloud-system. In some examples, a computer program product is disclosed for a corresponding method with the features disclosed herein. Details and features disclosed on individual aspects of the present disclosure also apply to the other aspects of the present disclosure and vice versa.

In some examples, embodiments of the present disclosure provide a method for controlling a (preferably wireless) communication (over a network, for example over a mobile phone network) between a vehicle and at least one backend device (on the cloud side of the system) in a vehicle-to-cloud-system, especially from the vehicle side of the system, the method comprising:
establishing a connection (preferably network connection) between the vehicle and the at least one backend device (for example cloud server) with a keep alive timer, especially by an online connectivity unit of an electronic control unit of the vehicle sending a connect and/or subscribe message to the backend device,
setting a timer (may also be called keep open timer) smaller (or less) than or equal to the keep alive timer,
sending a message containing a payload from the vehicle to the at least one backend device, if no communication (in other words, when no messages were sent) between the vehicle and the at least one backend device has occurred within the timer (within the period set by the timer or until the time set by the timer), in order to keep the connection open.
   The message may, for example be a connect, subscribe or a publish message.

Embodiments of the method may be carried out in the given order or in a modified order. In some embodiments, certain method steps may be carried out simultaneously and/or repeatedly to allow a flowing process, for example for different connections. In some embodiments, sending a message may be carried out periodically with the period equal to the timer being set.

### BRIEF DESCRIPTION OF THE DRAWINGS

The present disclosure and its further developments as well as its advantages will be explained in more detail below using figures. The figures show schematically:

FIG. 1 shows a schematic design of an electronic control unit under some aspects of the present disclosure.

### DETAILED DESCRIPTION

Aspects of the present disclosure are directed to publishing useful messages to keep connection between a vehicle and network open, without hindering the network with non-useful messages, just inside a maximum timeout window defined with a keep-alive timer. For this aim, a special timer may be set. Then a useful message, that is the message having a payload, may be sent. In case no useful information can be provided by the vehicle to the cloud, at least a status information (moving, parking, motor on, motor off or the like) may be sent to the backend device. The payload of the status information is not large. Also no answer or acknowledgment message to the message with the status information is needed from the cloud. Thus, the network will not be unnecessarily overloaded. No other participants in the vehicle-to-cloud-system are needed to keep the connection open between the vehicle and the at least one backend device. Also, no separate efforts are needed from the side of the backend device.

The present disclosure may provide improved connectivity in a publish-subscribe messaging environment ensuring that the established connection is open. Especially the present disclosure may provide fast, reliable and highly responsive mobile online services for the vehicle devices in a publish-subscribe messaging environment ensuring that the network is not overloaded. Latency times may be reduced or even avoided. Also, the functionality of the electronic control unit and the vehicle may be considerably improved in this way for more safety, intelligence, environmental friendliness and customer-friendly and comfortable operations as well as enjoyable operations.

In some examples, the payload in the message may include a vehicle state, and/or the message is published by a vehicle state provider. Thus, the traffic in the network may be reduced. No answer to such message is needed. When knowing the vehicle state, the backend device may optimize some services concerning the vehicle. When a vehicle is not in motion, for example, it does not need updated GPS data. A moving vehicle, for example, does not need comfort services such as automatically switching the light on or off.

In some examples, the payload in the message may include application-specific data from at least one vehicle device and/or the message is published by at least one of the following vehicle devices:
sensor device, such as crash-sensor, velocity sensor, and so on,
safety device, such as breakdown call, emergency call,
environment device, such as weather forecast, pollutant load sensor, environmental zone detection unit,
information device, for example for online traffic information, online destination import, online route import, online POI search, my POIs, petrol stations, parking spaces, vehicle state report, time manager, weather, news and so on,
entertainment device, for example for streaming services, and/or
comfort device, such as door closing detectors, light off detectors, parking position detectors, vehicle state and/or condition detector, trip data base, user calendar, information call and so on.

Thus, useful information may be provided to the backend device. Thus, also the quality of service provided by the backend device to the vehicle may be improved.

In some examples, the timer may be set as the keep-alive timer minus 1 second, or the timer may be set to a time in a range of (that is a time between two time moments) 0.5 to 0.99, especially 0.7 to 0.95, preferably 0.9 times the time of the keep-alive timer. Thus, an easy mechanism with reduced computing effort may be provided to set the timer.

In some examples, the timer may be set manually by an user of the vehicle, especially by operating an input device, preferably a display device at a vehicle dashboard, of the vehicle. A user being able to set the timer may increase user friendliness and/or customer satisfaction.

In some examples, the timer may set automatically by an electronic control unit of the vehicle. Thus, automatic settings for the timer may be provided.

In some examples, a confirmation and/or adjustment possibility of the timer is provided for an user of the vehicle, especially by operating an input device, for example a display device at a vehicle dashboard, of the vehicle. Thus, the user may keep an overview of the timer, without the burden of making the decisions about the timer.

In some examples, the method described herein may further include, before sending the message, carrying out a verification if sending is possible, wherein especially a communication test to the backend device is carried out. In this way, the situations may be tracked where the connectivity is lost not by lack of use of the connection but by network problems, for example by driving through a tunnel, bad network coverage and so on.

In some examples, the present disclosure provides an electronic control unit comprising: a memory, in which a program code is stored, and a computing unit, wherein when carrying out the program code by the computing unit, a method is performed as described above. With embodiments of the electronic control unit the same advantages may be achieved as with corresponding embodiments of the method described above. Full reference is made to these advantages in the present case.

In some examples, the electronic control unit may include a vehicle state provider configured to provide the payload in the message, wherein the electronic control unit includes a power manager connected to the vehicle state provider. In this way, the power control of the vehicle may be improved with the inventive functionality. Thus, the network may be facilitated. The safety, efficiency and the latency of online services provided by the backend device to the vehicle may then be improved. Also the online services provided by the backend device may be adapted to the current state of the vehicle in an advantageous way.

In some examples, the electronic control unit may include a wakeup manager, whereas the wakeup manager may be configured to be deactivated or inactive if embodiments of the above described method are performed, and wherein the wakeup manager is configured to reactivate the connection by sending a PING request message to the at least one corresponding backend device. Thus, a double safety mechanism to keep the open connection alive may be provided.

In some examples, the electronic control unit comprises a managing connecting gateway for routing the messages between a plurality of vehicle devices and a variety of backend devices, wherein the managing connecting gateway is configured to transmit the message to the variety of backend devices. Thus, the multiple cross connections between different vehicle devices and various backend devices may be kept open.

According to the third aspect, the present disclosure provides a vehicle comprising an embodiment of the electronic control unit as described above. With embodiments of such vehicle the same advantages may be achieved as with corresponding embodiments of the method described above. Full reference is made to these advantages in the present case.

A vehicle according to the present disclosure may include a plurality of vehicle devices, the plurality of vehicle devices being communicatively coupled (e.g. via a wireless connection, such as Wi-Fi or via a wired connection such as a CAN-bus, a LIN-Bus or an Ethernet connection) to the electronic control unit for connection to the at least one corresponding backend device, wherein the plurality of vehicle devices comprise at least one of the following devices:
sensor device, such as crash-sensor, velocity sensor, and so on,
safety device, such as breakdown call, emergency call,
environment device, such as a weather forecast, pollutant load sensor, environmental zone detection unit,
information device, for example for online traffic information, online destination import, online route import, online POI search, my POIs, petrol stations, parking spaces, vehicle state report, time manager, weather, news and so on,
entertainment device, for example for streaming services, and/or
comfort device, such as door closing detectors, light off detectors, parking position detectors, vehicle state and/or condition detector, trip data base, user calendar, information call and so on.

Thus, advantageously mobile online services with improved connectivity may be flexibly provided with the help of the vehicle in a flexible way.

Another advantage of the present disclosure may be achieved with providing a corresponding vehicle-to-cloud-system.

According to some examples, the present disclosure provides a computer program product comprising a program code for carrying out a method as described above. In other words, the computer program product comprises instructions which, when the program is executed by a computer, cause the computer to carry out an embodiment of the method as described above. With embodiments of the computer program product the same advantages may be achieved as with corresponding embodiments of the method described above. Full reference is made to these advantages in the present case.

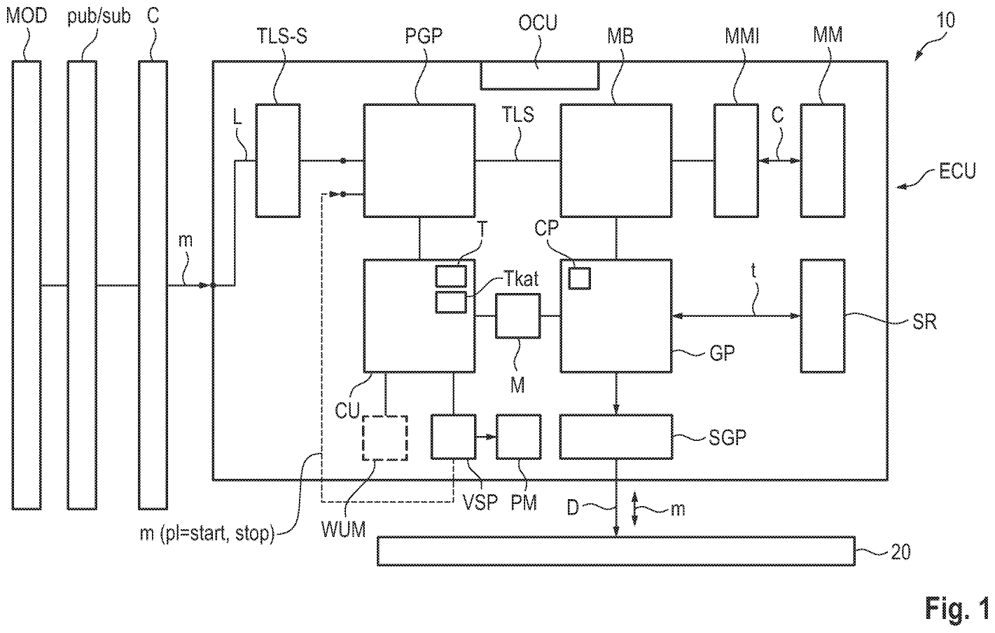

FIG. 1 illustrates different aspects of the present disclosure, such as a method for controlling a communication between a vehicle 10 and at least one backend device 20 (for example a cloud server) in a vehicle-to-cloud-system, a corresponding electronic control unit ECU, a corresponding vehicle 10 (not shown in detail for reasons of simplicity only) as well as a corresponding computer program product. Furthermore, a corresponding vehicle-to-cloud-system may be also provided.

Embodiments of a method for controlling a communication between the vehicle 10 and the at least one backend device 20 may include the following. First, at least one (network) connection D is established between the vehicle 10 and the at least one backend device 20 with a keep-alive timer Tkat, such as an online connectivity unit OCU of an electronic control unit ECU of the vehicle 10 sending a connect and/or subscribe message m to the backend device 20. Additionally, a timer T (may also be called keep-open timer) may beset smaller (or less) than or equal to the keep-alive timer Tkat. A message m is sent from the vehicle 10 to the at least one backend device 20. The message contains a payload pl. The message m may be a connect, subscribe or a publish message—The message m is sent, if no communication has occurred between the vehicle 10 and the at least one backend device 20 within the timer T, that is when no messages m between the vehicle 10 and the at least one backend device 20 were sent within the timer T, in order to keep the connection D open.

In some examples, a useful message m containing a payload pl is provided to keep the connection D open, without waste to the network with non-useful messages. That is, the connection D is kept op with messages with payload without using messages sent for the sole purpose to keep the connection upon instead or additionally. The useful message m is sent just inside the keep-alive timer Tkat as maximum.

For this purpose, a timer T is set. The timer T may be set as the keep-alive timer Tkat minus 1 second. Alternatively, the timer T may be set as a time in a range of 0.5 to 0,99, especially 0.7 to 0,95, preferably 0.9 times the time of the keep-alive timer Tkat. Thus, an easy mechanism to set a timer T may be provided.

It is possible that a user may set the timer T manually, for example by operating an input device, for example in the form of a display device at a vehicle dashboard 12.

Instead of a manual setting of the timer or in addition to this, the timer T may be set automatically by an electronic control unit ECU of the vehicle 10. Thus, automatic setting of the timer T may be provided. In such case a confirmation and/or adjustment possibility of the automatically set timer T may be provided for a user of the vehicle 10, for example by operating an input device, for example in the form of a display device at a vehicle dashboard.

Before sending the message m, a verification may be carried out, if sending is possible, wherein especially a communication test to the backend device 20 may be carried out.

With respect to the message m, the payload pl may provide information about a vehicle state (such as pl=start or stop). In this case, the message m may be published by a vehicle state provider VSP. The vehicle state provider VSP may be connected to a power manager PM of the vehicle 10. To send the vehicle state start or stop, the added information to the message m cannot be too large. No answer to such message m is needed. Also, when knowing the vehicle 10 state start or stop, the backend device 20 may optimize many online services for the vehicle 10.

Instead of, or in addition to, a vehicle state start or stop, the payload pl in the message m may contain application-specific data from at least one vehicle device MOD. In this case, the message m may be published by at least one of the following vehicle devices MOD:
sensor device, such as crash-sensor, velocity sensor, and so on,
safety device, such as breakdown call, emergency call,
environment device, such as weather forecast, pollutant load sensor, environmental one detection unit,
information device, for example for online traffic information, online destination import, online route import, online Point-of-Interest (POI) search, my POIs, petrol stations, parking spaces, vehicle state report, time manager, weather, news and so on,
entertainment device, for example for streaming services, and/or
comfort device, such as door closing detectors, light off detectors, parking position detectors, vehicle state and/or condition detector, trip data base, user calendar, information call and so on.

The part of the electronic control unit ECU shown in FIG. 1 may also be called online connectivity unit OCU. The electronic control unit ECU has a memory M, in which a program code is stored, and a computing unit CU, wherein when carrying out the program code by the computing unit CU, a method may be performed as described above.

In the embodiment depicted in FIG. 1, the electronic control unit ECU comprises a vehicle state provider VSP configured to provide the payload pl in the message m. Additionally, the electronic control unit ECU comprises a power manager PM connected to the vehicle state provider VSP. Nevertheless, the present disclosure may provide that the electronic control unit ECU comprises a wakeup manager WUM, whereas the wakeup manager WUM may be deactivated or inactive, when the method according to one of the proceeding claims is performed. Thus, the wakeup manager WUM may provide a fail back option to reactivate the connection D by sending a PING request message to the at least one corresponding backend device 20.

The electronic control unit ECU may provide connectivity subunits C, so called Message Queuing Telemetry Transport (MQTT) clients, for the vehicle devices MOD. The backend device 20 may then be called MQTT server. FIG. 1 shows only schematically the example of one vehicle device MOD and one backend device 20, wherein a plurality of vehicle devices MOD and a variety of backend devices 20 may be provided within the meaning of the present disclosure.

The vehicle devices MOD may subscribe to a publish-subscribe messaging environment pub/sub using different topics t provided by the at least one backend device 20 or even various backend devices 20. The publish-subscribe messaging environment pub/sub may use, for example, the MQTT protocol. The at least one backend device 20 or even various backend devices 20 may provide mobile online services (or in other words cloud-computing applications) for the vehicle devices MOD.

As it may be further seen from FIG. 1, the electronic control unit ECU may comprise a managing connecting gateway GP for routing the messages m between a plurality of vehicle devices MOD and a variety of backend devices 20, whereas the message m is transmitted by the managing connecting gateway GP to the variety of backend devices 20. The managing connecting gateway GP may provide bridges to the various backend devices 20 for different vehicle devices MOD according to the topics t to which the vehicle devices MOD are subscribed.

As FIG. 1 schematically indicates, the electronic control unit ECU may comprise a project connecting gateway PGP (for example in form of local MQTT broker of a “Mosquitto” protocol type) connected to the plurality of the connectivity subunits C over corresponding communication lines L. The project connecting gateway PGP is connected to the a managing connecting gateway GP over a communication line TLS by means of a TLS-Server TLS-S. The project connecting gateway PGP may provide a MQTT bridge MB to the managing connecting gateway GP.

At the MQTT bridge MB the managing connecting gateway GP may use a manifest manager MM and an MQTT manifest manager interface MMI to identify the connectivity subunits C connected to the project connecting gateway PGP. Further, the managing connecting gateway GP may use a service router SR to translate the topics t to which the connectivity subunits C are subscribed.

Advantageously, the managing connecting gateway GP may comprise a subscription mapping repository Map for the different topics t provided by various backend devices X, Y, Z and for the connectivity subunits C subscribed to the different topics t. The managing connecting gateway GP may address messages m using a topic routing to distribute the messages m to the right backend device 20. If a message m published by one vehicle device MOD has a topic t that is supported by multiple backend devices 20, then this message m may be correspondingly forwarded to matching backend devices 20. Also, if a message m published by a backend device 20 has a topic t to which multiple vehicle devices MOD are subscribed, this message m may be correspondingly forwarded to matching vehicle devices MOD.

The managing connecting gateway GP may include a proxy server SGP to translate the messages m and/or to provide authentication and/or authorization between the plurality of the vehicle device MOD and the various backend devices 20. The present disclosure may foresee that the managing connecting gateway GP decrypts the messages m for purposes of routing to the various backend devices 20. After assigning messages m to the corresponding backend devices 20, the messages m may be encrypted again.

If a plurality of backend devices 20 are connected to the vehicle 10, the message m containing the payload pl will be transmitted by the managing connecting gateway GP to all backend devices 20 to keep all bridges or all connections D to all backend devices 20 open.

The above description of the figures describes the present disclosure only in the context of examples. Of course, individual features of the embodiments may be combined with each other, provided it is technically reasonable, without leaving the scope of the present disclosure.

Reference signs

| | |
|---|---|
| 10 | vehicle |
| 20 | backend device |
| pub/sub | publish-subscribe messaging environment |
| t | topic |
| m | message |
| pl | payload |
| D | connection |
| T | timer |
| Tkat | keep-alive timer |
| ECU | electronic control unit |
| OCU | online connectivity unit |
| CU | computing unit |
| M | memory |
| VSP | vehicle state provider |
| start, stop | vehicle state |
| VUM | wake up manager |
| PM | power manager |
| C | connectivity subunits |
| MOD | vehicle device |
| GP | managing connecting gateway |
| Map | subscription mapping repository |
| PGP | project connecting gateway |
| MB | MQTT bridge |
| MM | manifest manager |
| MMI | MQTT manifest manager interface |
| SR | service router |
| TLS | TLS communication line |
| TLS-S | TLS server |
| L | communication line |
| SGP | proxy server |

1-15. (canceled)

16. A method for controlling a communication between a vehicle and at least one backend device in a vehicle-to-cloud-system, the method comprising:
establishing a connection between the vehicle and the at least one backend device with a keep-alive timer;
setting a timer to a value less than or equal to the keep alive timer; and
sending a message comprising a payload from the vehicle to the at least one backend device, if no communication between the vehicle and the at least one backend device has occurred within the timer, in order to keep the connection open.

17. The method according to claim 16, wherein the payload in the message comprises a vehicle state, and/or the message is published by a vehicle state provider.

18. The method according to claim 16, wherein the payload in the message comprises application-specific data from at least one vehicle device and/or the message is published by at least one of the following vehicle devices:
a sensor device,
a safety device,
an environment device,
an information device,
an entertainment device, and/or
a comfort device.

19. The method according to claim 16, wherein the timer value is set as a range that is 0.5 to 0.99 of the keep-alive timer value.

20. The method according to claim 16, wherein the timer is set automatically by an electronic control unit (ECU) of the vehicle.

21. The method according to claim 16, further comprising receiving a confirmation and/or adjustment possibility of the timer from an input device of the vehicle.

22. The method according to claim 16, wherein the method further comprises carrying out a verification to determine if sending is possible before sending the message.

23. An electronic control unit (ECU) for controlling a communication between a vehicle and at least one backend device in a vehicle-to-cloud-system, comprising:
a memory;
a vehicle state provider (VSP), operatively coupled to the memory; and
a computing unit, operatively coupled to the memory, wherein the computing unit and memory are configured to
establish a connection between the vehicle and the at least one backend device with a keep-alive timer;
set a timer to a value less than or equal to the keep alive timer; and
send a message comprising a payload, via the VSP, from the vehicle to the at least one backend device, if no communication between the vehicle and the at least one backend device has occurred within the timer, in order to keep the connection open.

24. The ECU according to claim 23, wherein the payload in the message comprises a vehicle state, and/or the message is published by a vehicle state provider.

25. The ECU according to claim 23, wherein the payload in the message comprises application-specific data from at least one vehicle device and/or the message is published by at least one of the following vehicle devices:
a sensor device,
a safety device,
an environment device,
an information device,
an entertainment device, and/or
a comfort device.

26. The ECU according to claim 24, wherein the timer value is set as a range that is 0.5 to 0.99 of the keep-alive timer value.

27. The ECU according to claim 23, wherein the computing unit and memory are configured to set the timer automatically.

28. The ECU according to claim 23, wherein the computing unit and memory are configured to receive a confirmation and/or adjustment possibility of the timer from an input device of the vehicle.

29. The ECU according to claim 23, wherein the computing unit and memory are configured to carry out a verification to determine if sending is possible before sending the message.

30. A computer-readable medium having stored therein instructions executable by one or more processors of an electronic control unit (ECU) for controlling a communication between a vehicle and at least one backend device in a vehicle-to-cloud-system, the instructions being configured to:
establish a connection between the vehicle and the at least one backend device with a keep-alive timer;
set a timer to a value less than or equal to the keep alive timer; and
send a message comprising a payload from the vehicle to the at least one backend device, if no communication between the vehicle and the at least one backend device has occurred within the timer, in order to keep the connection open.

31. The computer-readable medium according to claim 30, wherein the payload in the message comprises a vehicle state, and/or the message is published by a vehicle state provider.

32. The computer-readable medium according to claim 30, wherein the payload in the message comprises application-specific data from at least one vehicle device and/or the message is published by at least one of the following vehicle devices:
a sensor device,
a safety device,
an environment device,
an information device,
an entertainment device, and/or
a comfort device.

33. The computer-readable medium according to claim 30, wherein the timer value is set as a range that is 0.5 to 0.99 of the keep-alive timer value.

34. The computer-readable medium according to claim 30, wherein the timer is set automatically by an electronic control unit (ECU) of the vehicle.
